(19) United States
(12) Patent Application Publication
(10) Pub. No.: US 2003/0136681 A1
(43) Pub. Date: Jul. 24, 2003

(54) Method for fast thickening electroforming stamper

(76) Inventor: Jui Lung Tsai, Tai-Ping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/052,359

(22) Filed: Jan. 23, 2002

(51) Int. Cl. C25D 1/00; B41N 1/04

(52) U.S. Cl. 205/67; 205/69

(57) ABSTRACT

A method for fast thickening electroforming stamper, in which a substrate is placed in an electroforming tank and electroforming to form a first electroforming layer on the face of the substrate. A first thickening material is connected with a face of the first electroforming layer distal from the substrate. The first thickening material, the first electroforming layer and the substrate together form a combination body. After the substrate is separated from the first electroforming layer, at least the first electroforming layer and the first thickening material together form a stamper.

### BACKGROUND OF THE INVENTION

The present invention is related to a method for fast thickening electroforming stamper, in which only a thinner electroforming layer is electroforming and a thickening material is connected with the electroforming layer to quickly thicken the stamper and shorten electroforming time.

Conventionally, a stamper is manufactured in such a manner that a substrate having numerous fine structures on the surface is directly electroforming to form an electroforming layer (such as Nickel layer) with a certain thickness. In the case that the stamper is used in plastic injection mold, generally the stamper is necessary to have a certain thickness such as 20 mm.

In general, it takes 24 hours to form an electroforming layer with a thickness of 1 mm. Therefore, it will take 20 days to form an electroforming layer with 20 mm thickness. Such electroforming operation is time-consuming and not economical.

Moreover, when electroforming a substrate having numerous fine structures on the surface, in case of minor error, it will be necessary to re-electroforming and process the substrate. Under such circumstance, the operation efficiency will be even lower.

FIG. 6 shows the manufacturing method for a conventional mold. The surface of the mold original pattern 71 is first electroforming to form a mold face shell layer 72. Then the shell layer 72 is cleaned by means of a sand spraying device. Then, by way of arc spray welding, metallic wire material is sprayed onto the surface of the electroforming layer to form a spray welding layer 73. Then the spray welding layer 73 is processed. Then, by means of vacuum hard welding, the spray welding layer 73 and the mold board 74 are connected.

According to the above measure, the mold can be thickened simply by means of electroforming a thin mold face shell layer 72 and then processing the shell layer 72. Therefore, the mold can be formed in shortened time. However, the surface of the shell layer 72 is generally formed with fine structures corresponding the mold. Therefore, when sand-blasting the shell layer 72, the shell layer 72 tends to be damaged by high pressure impact. This will affect the precision of the stamper.

### SUMMARY OF THE INVENTION

It is therefore a primary object of the present invention to provide a method for fast thickening electroforming stamper, in which only a thinner electroforming layer is electroforming and a thickening material is connected with the electroforming layer to quickly thicken the stamper and shorten electroforming time.

It is a further object of the present invention to provide the above method for fast thickening electroforming stamper, in which the substrate is first electroforming to form a first electroforming layer. A face of the first electroforming layer adjacent to the substrate serves as a mold face complementary to the dented and projecting structures of the substrate. A lower surface of a thickening material is sand-blasted and then connected with the other face of the first electroforming layer opposite to the mold face. Accordingly, the mold face of the first electroforming layer is prevented from being deformed and damaged.

The present invention can be best understood through the following description and accompanying drawings wherein:

### BRIEF DESCRIPTION OF THE DRAWINGS

FIG. 1 is a flow chart of a first embodiment of the present invention;

FIG. 2A schematically shows the first embodiment of the present invention;

FIG. 2B is an enlarged view of the circled area of FIG. 2A;

FIG. 3 is a flow chart of a second embodiment of the present invention;

FIG. 4 schematically shows the second embodiment of the present invention;

FIG. 5 schematically shows a third embodiment of the present invention, in which the mold steel and the first electroforming layer are connected by means of laser beam; and

FIG. 6 shows a conventional manufacturing method for a mold.

### DETAILED DESCRIPTION OF THE PREFERRED EMBODIMENTS

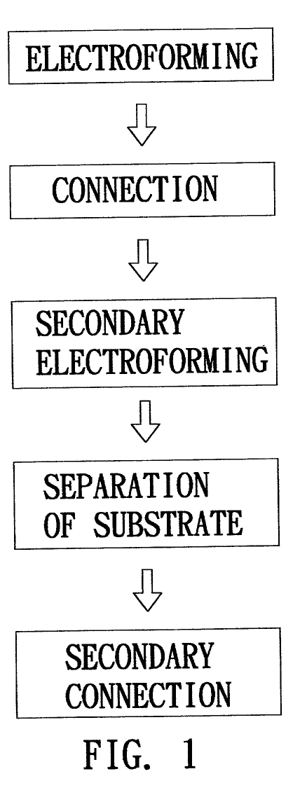

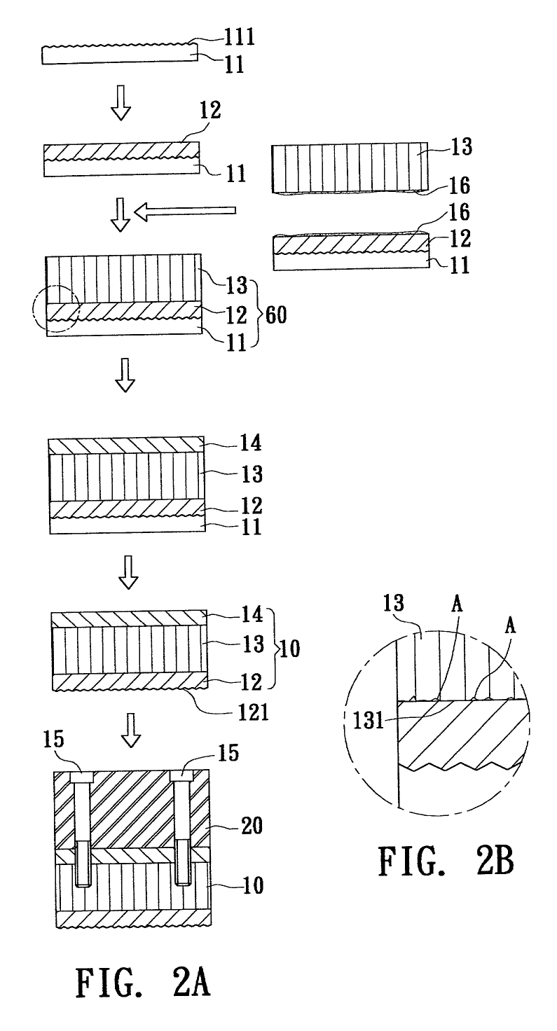

Please refer to FIGS. 1, 2A and 2B. The method for fast thickening electroforming stamper of the present invention includes steps of:

electroforming: A substrate 11 is placed in an electroforming tank (not shown). The substrate 11 can be made of a nonconductive material such as acrylic and glass or a conductive material such as mold steel or other material known by those skilled in this field. The substrate 11 has a processing face 111. By means of a conventional yellow or mechanical processing technique, the processing face 111 is previously formed with a predetermined number of dented and projecting structures having predetermined configuration. A predetermined amount of electroforming bath is contained in the electroforming tank. The electroforming bath is nickel sulfamate (Ni(SO₃NH₂)₂). A proper operation current density (2ASD-8ASD, wherein ASD is ampere/100 cm²) is applied to the substrate 11 and the electroforming bath at different electrodes. Through electroforming sedimentation, a first electroforming layer 12 is formed on the processing face 111 of the substrate 11. A face of the first electroforming layer 12 adjacent to the processing face 111 is formed as a mold face 121 complementary to the dented and projecting structures of the processing face 111. The first electroforming layer 12 has a thickness of about 1˜2 mm;

connection: A spray gun (not shown) is used to sand-blast a first thickening material. In this embodiment, the first thickening material is a first mold steel 13. The lower surface 131 of the first mold steel 13 is roughed by means of sand-blasting. The hardness of the first mold steel 13 is within HRc30˜40. An adhesive 16 (such as silver glue BR57 or tin paste) is used to adhere the lower surface 131 of the first mold steel 13 to one face of the first electroforming layer 12 distal from the substrate 11. The first mold steel 13, first electroforming layer 12 and the substrate 11 together form a combination body 60;

secondary electroforming: The combination body 60 is placed back into the electroforming tank for secondary electroforming. A second electroforming layer 14 is formed on the surface of the first mold steel 13. The second electroforming layer 14 has a thickness of about 1˜2 mm. When secondarily electroforming, metal ion will also attach to the gap A between the first mold steel 13 and the first electroforming layer 12 (as shown in FIG. 2B);

separation: The substrate 11 is separated from the first electroforming layer 12 by a mechanical measure. The first electroforming layer 12, first mold steel 13 and the second electroforming layer 14 together form a metal layer 10 having a thickness of about 8 mm˜10 mm; and

second connection: The metal layer 10 is drilled with multiple thread holes, whereby bolts 15 can be used to lock the metal layer 10 on a second thickening material. In this embodiment, the second thickening material is a second mold steel 20. The hardness of the second mold steel 20 is within HRc30˜40. The second mold steel 20 has a thickness cooperating with the metal layer 10 to form a stamper with a thickness of about 20 mm.

According to the above, for manufacturing a 20 mm stamper, only two times of electroforming are necessary. An electroforming layer 12, 14 of 1˜2 mm is formed in each time of electroforming. That is, totally 2˜4 mm electroforming layers are necessary. In comparison to the 20 mm electroforming layer in the conventional measure, the manufacturing time is greatly shortened.

In order to avoid polished surface of the first electroforming layer 12 and difficulty in adhesion, when adhering the first mold steel 13 to the first electroforming layer 12, the surface of the first mold steel 13 is previously sand-blasted to increase the adhesion area and frictional force between the surfaces of the first mold steel 13 and the first electroforming layer 12. Therefore, the first mold steel 13 and the first electroforming layer 12 can be firmly adhered to each other.

Moreover, the surface of the first mold steel 13 is sand-blasted instead of the first electroforming layer 12 so that the mold face 121 of the first electroforming layer 12 will not be damaged by the high pressure of sand-blasting operation. Accordingly, the first electroforming layer 12 and the mold face 121 of the stamper are prevented from being deformed and damaged.

When electroforming the second electroforming layer 14, the metal ion will also attach to the gap A between the first electroforming layer 12 and the first mold steel 13 (as shown in FIG. 2B). Therefore, the fissure between the first mold steel 13 and the first electroforming layer 12 is filled.

The first and second thickening materials can be other materials known by those skilled in this field.

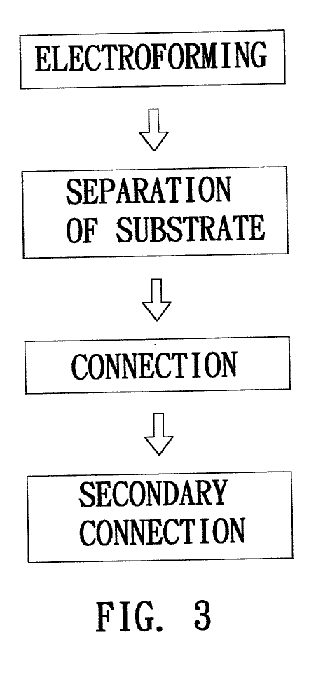

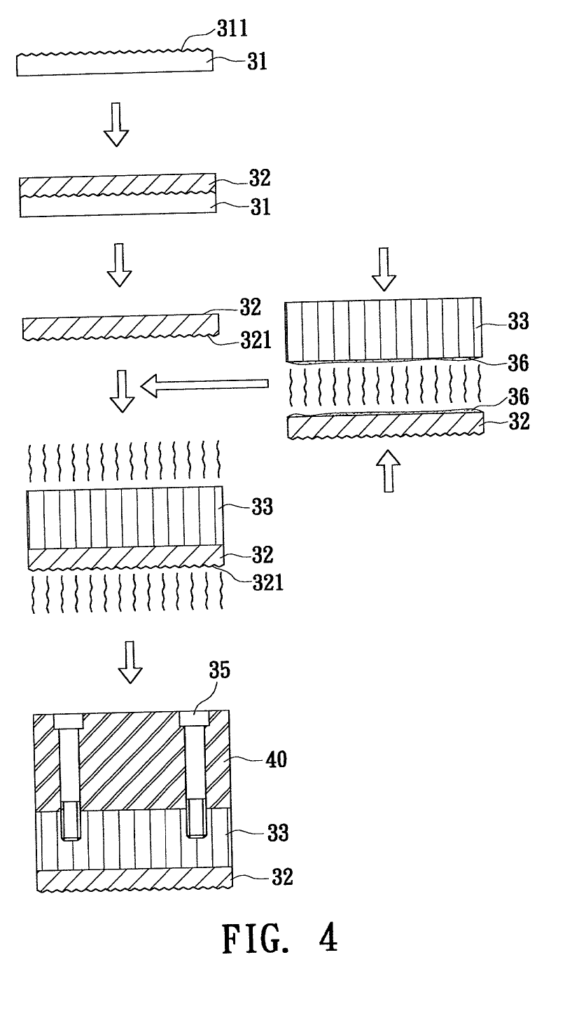

FIGS. 3 and 4 show a second embodiment of the present invention which includes steps of:

electroforming: A substrate 31 is placed in an electroforming tank as in the first embodiment. The substrate 31 has a processing face 311. The processing face 311 is previously formed with a predetermined number of dented and projecting structures having predetermined configuration. A predetermined amount of electroforming bath is contained in the electroforming tank. A proper current is applied to the substrate 31 and the electroforming bath. Through electroforming sedimentation, a first electroforming layer 32 is formed on the processing face 311 of the substrate 31. A face of the first electroforming layer 32 adjacent to the processing face 311 is formed as a mold face 321 complementary to the dented and projecting structures of the processing face 311;

separation: The substrate 31 is separated from the first electroforming layer 32 by a mechanical measure;

connection: A welding agent 36 is painted over the surfaces of a first thickening material 33 and the first electroforming layer 32. The welding agent 36 is heated to combine the first thickening material 33 and the first electroforming layer 32 together. The first thickening material 33 and the first electroforming layer 32 are continuously heated and pressurized so as to firmly connect them with each other; and

second connection: The first thickening material 33 is drilled with multiple thread holes, whereby bolts 35 can be used to lock the first thickening material 33 and the first electroforming layer 32 on a second thickening material 40 to form a stamper.

In the second embodiment, after the first electroforming layer 32 is connected with the first thickening material 33, they are directly locked on the second thickening material 40. Therefore, the stamper can be quickly thickened.

Moreover, the first electroforming layer 32 has a mold face 321 corresponding to the dented and projecting structures of the substrate 31. Therefore, after the first electroforming layer 32 is connected with the first thickening material 33, it can be directly used as the stamper.

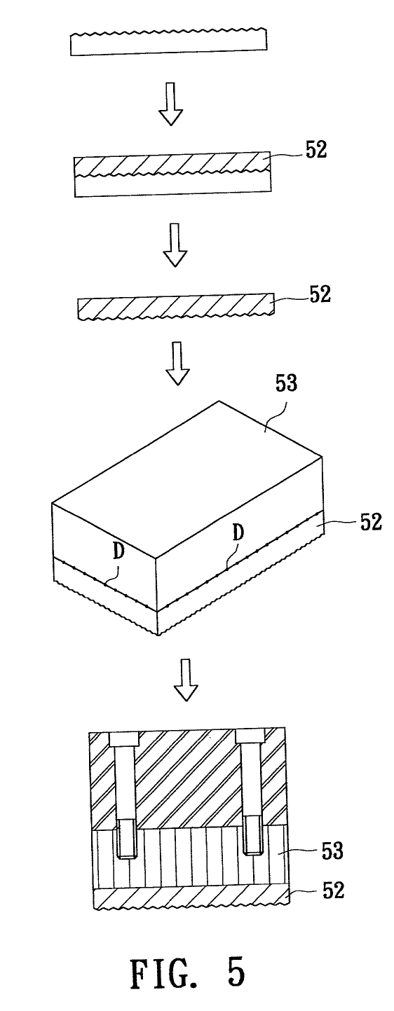

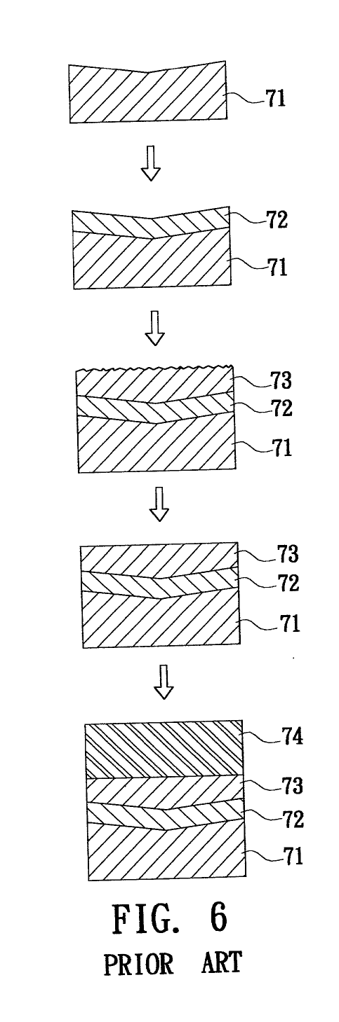

FIG. 5 shows a third embodiment of the present invention which is different from the second embodiment in that:

The first mold steel 53 is connected with the first electroforming layer 52 by means of laser beam. The laser beam (wavelength is 1064 μm) is evenly projected onto the periphery of the mold steel 53 and the first electroforming layer 52 (point D). The diameter of the laser beam is within 0.2˜0.6 mm. Each of the first thickening material 53 and the first electroforming layer 52 occupies one half of fusion point (0.1˜0.3 mm).

The first thickening material 53 is directly connected with the first electroforming layer 52 by means of laser beam so that the manufacturing efficiency of the stamper is more effectively increased. Such measure is able to achieve the same effect as the first embodiment.

The above embodiments are only used to illustrate the present invention, not intended to limit the scope thereof. Many modifications of the above embodiments can be made without departing from the spirit of the present invention.

What is claimed is:

1. A method for fast thickening electroforming stamper, in which a substrate is placed in an electroforming tank, the substrate having at least one processing face formed with a number of dented and projecting structures, a predetermined amount of electroforming bath being contained in the electroforming tank, a proper current being applied to the substrate and the electroforming bath at different electrodes, whereby through electroforming sedimentation, a first electroforming layer is formed on the processing face of the substrate, a face of the first electroforming layer adjacent to the processing face being formed as a mold face complementary to the dented and projecting structures of the processing face, a first thickening material being then connected with a face of the first electroforming layer distal from the substrate, the first thickening material, the first electroforming layer and the substrate together forming a combination body, the substrate being then separated from the first electroforming layer and the first electroforming layer and the first thickening material together forming a stamper.

2. The method for fast thickening electroforming stamper as claimed in claim 1, wherein the first electroforming layer has a thickness of about 1˜2 mm.

3. The method for fast thickening electroforming stamper as claimed in claim 1, wherein the surface of the first thickening material is previously roughed and then the first thickening material is adhered to the first electroforming layer by an adhesive.

4. The method for fast thickening electroforming stamper as claimed in claim 1, wherein a welding agent is first painted over the surfaces of a first thickening material and the first electroforming layer and then the welding agent is heated to combine the first thickening material and the first electroforming layer together.

5. The method for fast thickening electroforming stamper as claimed in claim 1, wherein the first thickening material is first leant on the first electroforming layer and then a laser beam is evenly projected onto the periphery of the first thickening material and the first electroforming layer so as to connect the first thickening material with the first electroforming layer.

6. The method for fast thickening electroforming stamper as claimed in claim 5, wherein the diameter of the laser beam is within 0.2˜0.6 mm.

7. The method for fast thickening electroforming stamper as claimed in claim 1, wherein after the first thickening material is connected with the first electroforming layer, a second electroforming layer being formed on one face of the first thickening material distal from the first electroforming layer, the second electroforming layer, the first thickening material and the first electroforming layer together forming a metal layer, a second thickening material being connected with a face of the metal layer distal from the first electroforming layer to form a stamper.

8. The method for fast thickening electroforming stamper as claimed in claim 7, wherein after the second electroforming layer is formed, the substrate is separated from the first electroforming layer, whereby the second electroforming layer, the first thickening material and the first electroforming layer together form a metal layer.

9. The method for fast thickening electroforming stamper as claimed in claim 1, wherein after the first electroforming layer is formed on the surface of the substrate, the substrate is separated from the first electroforming layer.

10. The method for fast thickening electroforming stamper as claimed in claim 1, wherein a face of the first thickening material of the combination body distal from the first electroforming layer is connected with a second thickening material, after the substrate is separated from the first electroforming layer, the second electroforming layer, the first thickening material and the first electroforming layer together forming a stamper.
